(19) United States
(12) Patent Application Publication
(10) Pub. No.: US 2007/0235065 A1
(43) Pub. Date: Oct. 11, 2007

(54) Food cleaning device

(75) Inventor: Chin-Yuag Lin, Taiping City (TW)

Correspondence Address: BACON & THOMAS, PLLC, 625 SLATERS LANE, FOURTH FLOOR, ALEXANDRIA, VA, 22314, US

(73) Assignee: KING STAR ENTERPRISE INC., San Gabriel, CA (US)

(21) Appl. No.: 11/401,237

(22) Filed: Apr. 11, 2006

(51) Int. Cl. B08B 3/00

(52) U.S. Cl. 134/94.1

(57) ABSTRACT

A food cleaning device has a housing, a liquid inlet, a magnetizing device and an ozone generating device. The housing has a space for containing liquid and an open top communicating with the space. The liquid inlet defined in the housing and communicating with the space. The magnetizing device is attached to the liquid inlet to magnetize the liquid led into the housing through the liquid inlet. The ozone generating device is mounted on the housing and is connected to the space in the housing to generate ozone supplied to the space in the housing. Accordingly, sterilizing, deodorization and cleaning effects are provided to foods with ozone generated by the ozone generating device.

### BACKGROUND OF THE INVENTION

1. Field of the Invention

The present invention relates to a food cleaning device, and more particularly to a food cleaning device having an ozone generating device to provide sterilizing, deodorization and cleaning effects to foods.

2. Description of Related Art

To clean foods, water is always used, but water is always polluted and contains bacteria such that water cannot clean foods even will pollute foods. Consequently, chlorine is always added into water to sterilize water. However, chlorine is a material that easily causes cancer to human and damages vitamins in foods, so that cleaning foods with water is unhealthy to people. In addition, some people cleans foods with boiling water to achieve sterilizing effect, but some foods, such as fruits, cannot be applied with boiling water.

To overcome the shortcomings, the present invention tends to provide a food cleaning device to mitigate or obviate the aforementioned problems.

### SUMMARY OF THE INVENTION

The main objective of the invention is to provide a food cleaning device that provides sterilizing, deodorization and cleaning effects to foods with ozone.

The food cleaning device has a housing, a liquid inlet, a magnetizing device and an ozone generating device. The housing has a space for containing liquid and an open top communicating with the space. The liquid inlet defined in the housing and communicating with the space. The magnetizing device is attached to the liquid inlet to magnetize the liquid led into the housing through the liquid inlet. The ozone generating device is mounted on the housing and is connected to the space in the housing to generate ozone supplied to the space in the housing.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a food cleaning device in accordance with the present invention;

FIG. 2 is a side plan view in partial section of the food cleaning device in FIG. 1;

FIG. 3 is an operational side plan view in partial section of the food cleaning device in FIG. 1 showing that the device is used for cleaning fruits;

FIG. 4 is an another operational side plan view in partial section of the food cleaning device in FIG. 1 showing that the device is used for cleaning a bamboo shoot; and

FIG. 5 is an exploded perspective view of another embodiment of a food cleaning device in accordance with the present invention.

### DETAILED DESCRIPTION OF PREFERRED EMBODIMENT

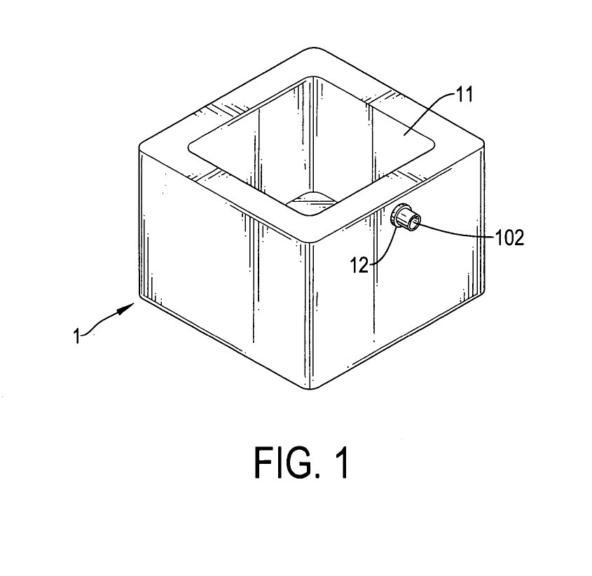

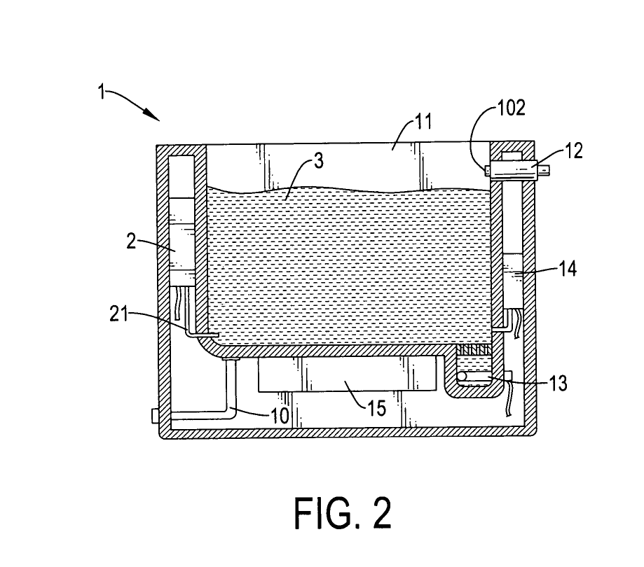

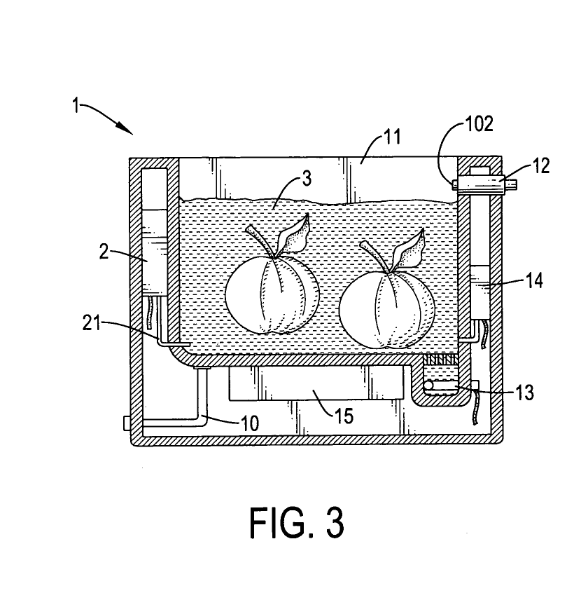

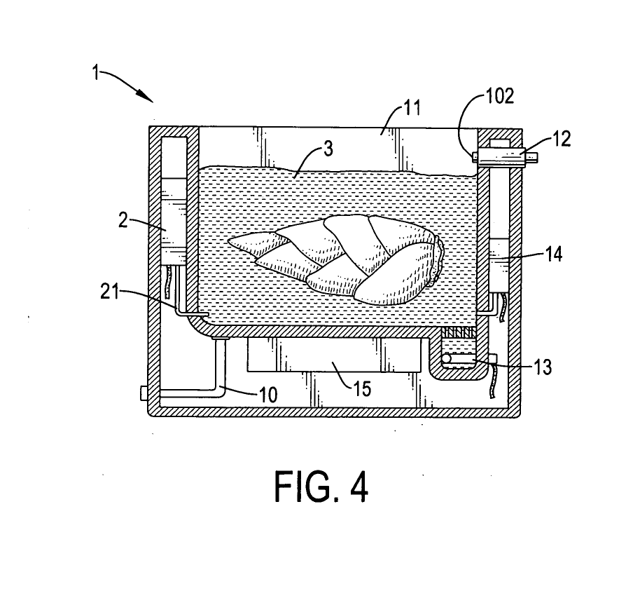

With reference to FIGS. 1 to 4, a food cleaning device in accordance with the present invention comprises a housing (1), an liquid inlet (102), a magnetizing device (12) and an ozone generating device (2). The housing (1) has a space (11) for containing liquid (3), such as water and foods, such as fruits as shown in FIG. 3 or a bamboo shoot as shown in FIG. 4. An open top is defined in the housing (1) and communicates with the space (11). The liquid inlet (102) is defined in the housing (1) and communicates with the space (11) to lead liquid into the space (11). In a preferred embodiment, the liquid inlet (102) is defined near the open top of the housing (1). In addition, a discharging tube (10) is connected to the bottom of the space (11) to discharge liquid from the space (11) when cleaning process is finished.

The magnetizing device (12) is attached to the liquid inlet (102) to magnetize the liquid (3) led into the housing (1) through the liquid inlet (102).

The ozone generating device (2) is mounted on the housing (1) and is connected to the space (11) in the housing (1) with a hose (21). Accordingly, ozone will be generated by the ozone generating device (2) and is supplied to the space (11) in the housing (1) through the hose (21). With the ozone applied into the liquid (3), sterilizing, deodorization and cleaning effects are provided.

In addition, a temperature controlling device (13), such as a heater is mounted on the housing (1) to heat the liquid (3) inside the space (11) in the housing (1). Accordingly, liquid (3) in the housing (1) can be heated to a desired temperature to provide an improved cleaning effect.

Furthermore, an air supplier (14) is mounted on the housing (1) to supply air into the liquid (3) inside the space (11) in the housing (1), such that a torrent liquid flow is generated in the liquid (3). With the torrent liquid flow, the foods inside the housing (1) can be fully cleaned.

Additionally, a vibrating device (15) is mounted on the housing (1). In a preferred embodiment, the vibrating device (15) is an ultrasonic vibrating device to generate tight bubbles in the liquid (3), such that oxygen content in the liquid (3) and contact areas between the liquid (3) and the cleaned foods are both increased so the cleaning effect is further improved.

With such an arrangement, the ozone provided by the ozone generating device (2) can provide an excellent sterilizing, deodorization and cleaning effects to foods.

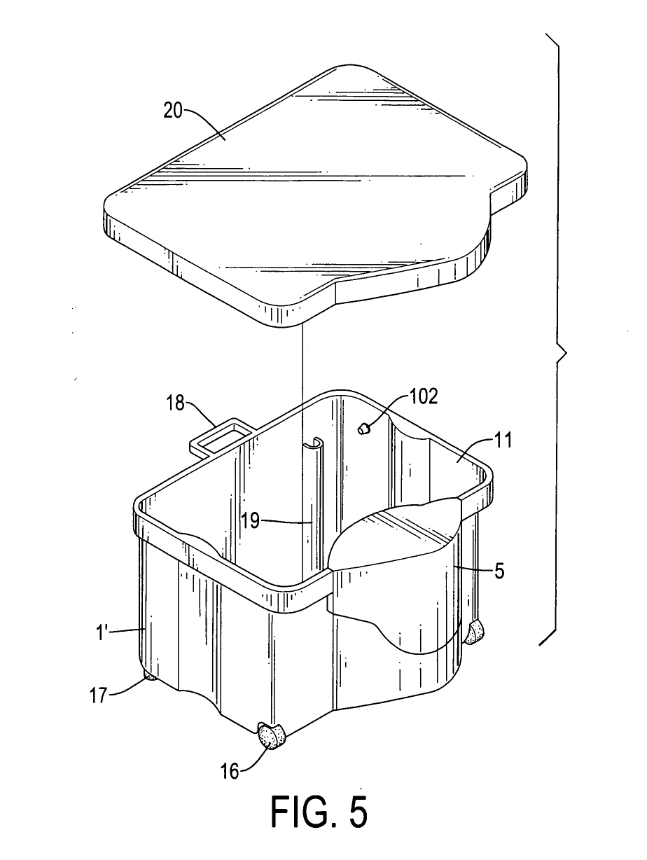

With reference to FIG. 5, the housing (1) further has multiple wheels (16) and feet (17) mounted on the bottom of the housing (1). With the arrangement of the wheels (16), the cleaning device is easily moved to any desired location for use. With the arrangement of the feet (17), the cleaning device can held in place in stable. A handle (18) is formed on the housing (1) for a usr conveniently carrying the cleaning device.

In addition, a casing (5) is attached to the housing (1), and the ozone generating device (2) and the air supplier (14) are held inside the casing (5). With the arrangement of the casing (5), the space (11) in the housing (1) can be effectively enlarged. Furthermore, a lid (20) is mounted on the housing (1) to close the open top of the housing (1).

Additionally, an overflow tube is mounted inside the space of the housing to keep liquid from overflowing from the open top of the housing.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A food cleaning device comprising:
a housing with a space for containing liquid and an open top communicating with the space;
a liquid inlet defined in the housing and communicating with the space;
a magnetizing device attached to the liquid inlet to magnetize the liquid led into the housing through the liquid inlet; and
an ozone generating device mounted on the housing and connected to the space in the housing to generate ozone supplied to the space in the housing.

2. The food cleaning device as claimed in claim 1 further comprising a temperature controlling device mounted on the housing to heat the liquid inside the space in the housing.

3. The food cleaning device as claimed in claim 2 further comprising an air supplier mounted on the housing to supply air into the liquid inside the space in the housing and to generate a torrent liquid flow in the liquid.

4. The food cleaning device as claimed in claim 3 further comprising a vibrating device mounted on the housing.

5. The food cleaning device as claimed in claim 4, wherein the housing further has multiple wheels mounted on a bottom of the housing.

6. The food cleaning device as claimed in claim 5, wherein the housing further has multiple feet mounted on the bottom of the housing.

7. The food cleaning device as claimed in claim 6 further comprising a casing attached to the housing, wherein the ozone generating device and the air supplier are held inside the casing.

8. The food cleaning device as claimed in claim 7 further comprising a lid mounted on the housing to close the open top of the housing.

9. The food cleaning device as claimed in claim 1 further comprising an air supplier mounted on the housing to supply air into the liquid inside the space in the housing and to generate a torrent liquid flow in the liquid.

10. The food cleaning device as claimed in claim 9 further comprising a vibrating device mounted on the housing.

11. The food cleaning device as claimed in claim 10, wherein the housing further has multiple wheels mounted on a bottom of the housing.

12. The food cleaning device as claimed in claim 11, wherein the housing further has multiple feet mounted on the bottom of the housing.

13. The food cleaning device as claimed in claim 12 further comprising a casing attached to the housing, wherein the ozone generating device and the air supplier are held inside the casing.

14. The food cleaning device as claimed in claim 13 further comprising a lid mounted on the housing to close the open top of the housing.

15. The food cleaning device as claimed in claim 1 further comprising a vibrating device mounted on the housing.

16. The food cleaning device as claimed in claim 1, wherein the housing further has multiple wheels mounted on a bottom of the housing.

17. The food cleaning device as claimed in claim 1, wherein the housing further has multiple feet mounted on the bottom of the housing.

18. The food cleaning device as claimed in claim 1 further comprising a lid mounted on the housing to close the open top of the housing.

19. The food cleaning device as claimed in claim 1 further comprising an overflow tube is mounted inside the space of the housing to keep liquid from overflowing from the open top of the housing.

20. The food cleaning device as claimed in claim 1, wherein the housing further has a handle formed on the housing.
